(19) United States
(12) Patent Application Publication
(10) Pub. No.: US 2020/0285437 A1
(43) Pub. Date: Sep. 10, 2020

(54) INFORMATION PROCESSING SYSTEM, INFORMATION PROCESSING APPARATUS, AND INFORMATION PROCESSING METHOD

(71) Applicant: Keisuke MORI, Tokyo (JP)

(72) Inventor: Keisuke MORI, Tokyo (JP)

(21) Appl. No.: 16/733,291

(22) Filed: Jan. 3, 2020

(30) Foreign Application Priority Data
Mar. 6, 2019 (JP) 2019-040902

(51) Int. Cl. G06F 3/12

(52) U.S. Cl. CPC G06F 3/1255; G06F 3/1238; G06F 3/1204

(57) ABSTRACT

An information processing system includes an information processing apparatus and a server apparatus connected to each other via a communication network. The server apparatus includes a first processor that transmits processing target information and processing restriction information to the information processing apparatus in response to a request from the image processing apparatus. The processing target information is to be processed by the information processing apparatus. The processing restriction information is associated with the processing target information. The information processing apparatus includes a second processor that transmits the request for the processing target information and the processing restriction information to the server apparatus, and applies the processing restriction information to information for displaying a list of items of the processing target information to generate processing target list information for display.

### CROSS-REFERENCE TO RELATED APPLICATION

This patent application is based on and claims priority pursuant to 35 U.S.C. § 119(a) to Japanese Patent Application No. 2019-040902 filed on Mar. 6, 2019 in the Japan Patent Office, the entire disclosure of which is hereby incorporated by reference herein.

### BACKGROUND

### Technical Field

The present invention relates to an information processing system, an information processing apparatus, and an information processing method.

### Description of the Related Art

There is an image information processing system including an image forming apparatus and an image information processing management apparatus communicably connected to each other via a communication network. The image forming apparatus performs image formation based on image formation information including image information. The image information processing management apparatus manages the image information and distributes the image formation information to the image forming apparatus. To maintain the confidentiality of the image information, a user authentication process may be performed on the image forming apparatus when a user executes an information output process (e.g., a printing process) with an image forming process based on the image information. There is also an information processing system that allows an authenticated user to instruct an image forming apparatus to perform a process such as output or deletion of image information stored in the information processing system by the user.

Further, to control a method of executing the printing process of the image formation information (i.e., a print job), there is a technique of determining a rule based on the method of inputting the print job and changing the execution of the print job based on the rule.

When this technique is applied to impose a restriction on the output process related to the image forming process, the values of output conditions individually set by a user are forcibly changed to preset values set by an information processing management apparatus (i.e., a printer server). The user recognizes the presence or absence of such a change and the contents of the change when instructing the image forming apparatus to execute the output process. That is, the user becomes aware of the restriction (i.e., condition) imposed on the output process after having selected an image information item to be output from a list of candidate image information items be output.

According to the technique, therefore, the user is unaware of the contents of the restriction on the image information item selected as the processing target until realizing the restriction on the output process at the above-described time.

### SUMMARY

In one embodiment of this invention, there is provided an improved information processing system that includes, for example, an information processing apparatus and a server apparatus connected to each other via a communication network. The server apparatus includes a first processor that transmits processing target information and processing restriction information to the information processing apparatus in response to a request from the image processing apparatus. The processing target information is to be processed by the information processing apparatus. The processing restriction information is associated with the processing target information. The information processing apparatus includes a second processor that transmits the request for the processing target information and the processing restriction information to the server apparatus, and applies the processing restriction information to information for displaying a list of items of the processing target information to generate processing target list information for display.

In one embodiment of this invention, there is provided an improved information processing apparatus connected to a server apparatus via a communication network. The information processing apparatus includes, for example, a processor. The processor transmits a request for processing target information and processing restriction information to the server apparatus, and applies the processing restriction information to information for displaying a list of items of the processing target information to generate processing target list information for display. The processing restriction information is associated with the processing target information.

In one embodiment of this invention, there is provided an improved information processing method executed by an information processing apparatus connected to a server apparatus via a communication network. The information processing method includes, for example, transmitting a request for processing target information and processing restriction information to the server apparatus, and applying the processing restriction information to information for displaying a list of items of the processing target information to generate processing target list information for display. The processing restriction information is associated with the processing target information.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a system configuration diagram illustrating an overview of a print management system as an example of an information processing system according to an embodiment of the present invention;

FIG. 2A is a hardware configuration diagram of a multifunction peripheral (MFP) as an example of an information processing apparatus according to an embodiment of the present invention;

FIG. 2B is a block diagram illustrating a functional configuration of a controller of the MFP;

FIG. 3 is a functional configuration diagram of the MFP;

FIG. 4 is a hardware configuration diagram of a printer server included in the print management system;

FIG. 5 is a functional block diagram of the printer server of the print management system;

FIG. 6 is a sequence diagram illustrating a procedure of an authentication process performed in the print management system;

FIG. 7 is a diagram illustrating an example of a launcher screen displayed on a display screen of the MFP;

FIGS. 8A and 8B are diagrams illustrating a data structure of a job information table stored in the printer server of the print management system;

FIGS. 9A and 9B are diagrams illustrating a data structure of a server information table stored in the printer server of the print management system;

FIG. 10 is a diagram illustrating an example of a setting screen of a client terminal included in the print management system;

FIG. 11 is a sequence diagram illustrating a procedure of a print job registration process performed in the print management system;

FIG. 12 is a sequence diagram illustrating a part of a procedure of a printing process performed in the print management system;

FIG. 13 is a diagram illustrating an example of a print job list display screen displayed on the MFP of the print management system;

FIG. 14 is a diagram illustrating a print job list display screen according to related art as a comparative example of the print job list display screen in FIG. 13;

FIG. 15 is a diagram illustrating an example of a rule display screen displayed on the MFP of the print management system;

FIG. 16 is a diagram illustrating an example of an attribute change screen displayed on the MFP of the print management system;

FIGS. 17A and 17B are diagrams illustrating an example in which a specific condition is changed on the attribute changed screen;

FIG. 18 is a sequence diagram illustrating a part of a procedure of an example of the printing process performed in the print management system;

FIG. 19 is a sequence diagram illustrating a part of a procedure of another example of the printing process performed in the print management system; and

FIG. 20 is a diagram illustrating an example of display on the MFP of the print management system during the printing process.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present invention will be described below with reference to the drawings. A print management system 1 will be described as an example of an information processing system according to an embodiment of the present invention. Further, a multifunction peripheral (MFP) 100 applicable to the print management system 1 will be described as an example of an information processing apparatus according to an embodiment of the present invention.

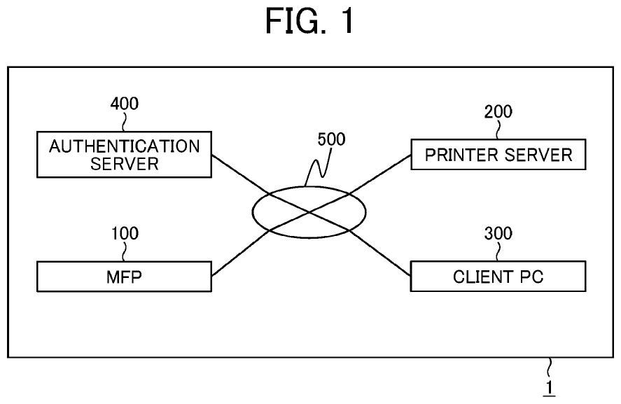

As illustrated in FIG. 1, the print management system 1 as an example of the information processing system according to an embodiment of the present invention includes at least the MFP 100, a printer server 200, a client personal computer (PC) 300, an authentication server 400, and a communication network 500.

The MFP 100 as an example of the information processing apparatus according to an embodiment of the present invention is an image forming apparatus that performs a process of outputting image information, for example.

The printer server 200 is an example of a server apparatus (i.e., an information processing management apparatus) according to an embodiment of the present invention. For example, the printer server 200 manages a print job (an example of processing target information) that is processed in the MFP 100. The printer server 200 further manages processing condition information that specifies processing conditions of the print job. The printer server 200 uniformly sets the processing condition information for items of the processing target information stored in the print management system 1.

The client PC 300 is an information processing apparatus that stores, in the printer server 200, the print job (i.e., the processing target information) to be subjected to an image forming process by the MFP 100. Alternatively, the client PC 300 may store the print job in a storage device thereof and transmit to the printer server 200 metadata representing the storage location of the print job such that the printer server 200 manages the metadata. In either case, when the MFP 100 executes the print job, the MFP 100 inquires of the printer server 200 about the location of the print job and acquires the print job to be processed based on the result of the inquiry.

The authentication server 400 executes an authentication process for a user to use the MFP 100. When requesting the processing of the print job with the MFP 100, the user inputs authentication information via the MFP 100 to request the authentication server 400 to execute the authentication process.

The communication method employed in the communication network 500 is not limited to a particular method, as long as the communication method enables the MFP 100, the printer server 200, the client PC 300, and the authentication server 400 to communicate information to each other. The communication via the communication network 500 may be wired communication or wireless communication.

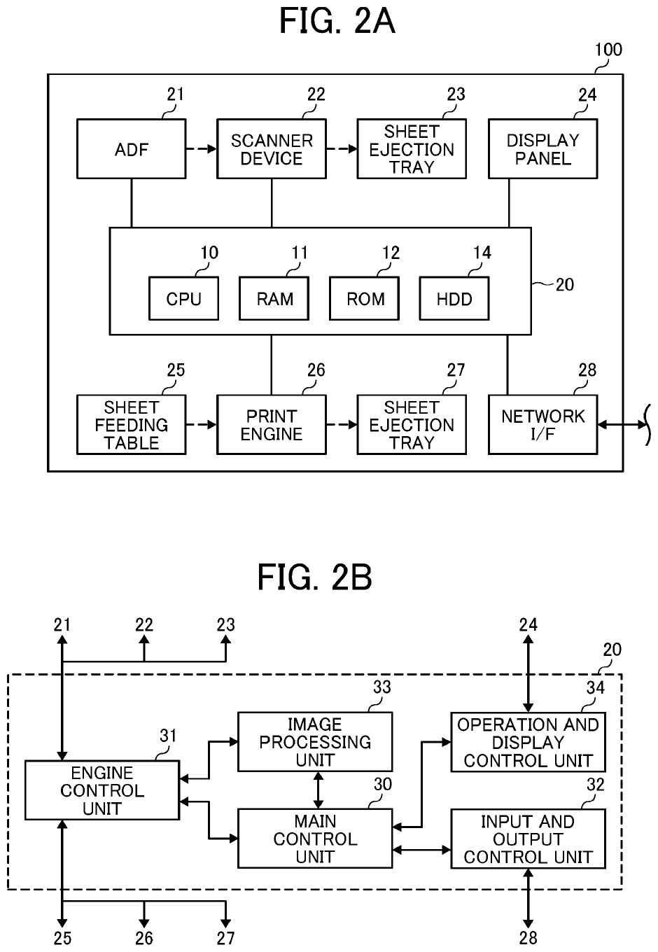

A hardware configuration of the MFP 100 of the embodiment will be described with FIG. 2A.

FIG. 2A is a hardware configuration diagram of the MFP 100 of the embodiment. FIG. 2B is a block diagram illustrating a functional configuration of a controller 20 of the MFP 100. The MFP 100 includes the controller 20, an automatic document feeder (ADF) 21, a scanner device 22, a sheet ejection tray 23, a display panel 24, a sheet feeding table 25, a print engine 26, a sheet ejection tray 27, and a network interface (I/F) 28. With the scanner device 22 and the print engine 26, the MFP 100 is implemented as a multifunction peripheral with a scanner function and a printer function. In FIGS. 2A and 2B, solid arrows indicate electrical connection, and broken arrows indicate the direction of transporting a recording medium (e.g., a transfer sheet).

The display panel 24 functions as an output interface that visually displays the state of the MFP 100 and as an input interface (i.e., an operation device) used as a touch panel by the user to directly operate the MFP 100 or input information to the MFP 100. The network I/F 28 is an interface for the MFP 100 to communicate with another apparatus via a network, and may conform to the Ethernet (registered trademark) or universal serial bus (USB) standard, for example.

The controller 20 includes a central processing unit (CPU) 10, a random access memory (RAM) 11, a read only memory (ROM) 12, and a hard disk drive (HDD) 14, for example. Specifically, control programs stored in nonvolatile memories such as the ROM 12 and the HDD 14 illustrated in FIG. 2A are loaded on a volatile memory such as the RAM 11, and the CPU 10 performs arithmetic operations in accordance with the control programs to implement functions of the controller 20 as a software control unit, as illustrated in FIG. 2B. At least a part of the functions illustrated in FIG. 2B may be implemented by hardware such as an integrated circuit (IC). The controller 20 functions as a control unit that controls the entire MFP 100. More specifically, the controller 20 implements functions of a main control unit 30, an engine control unit 31, an input and output control unit 32, an image processing unit 33, and an operation and display control unit 34, as illustrated in FIG. 2B.

The main control unit 30 issues commands to the engine control unit 31, the input and output control unit 32, the image processing unit 33, and the operation and display control unit 34 of the controller 20 to control these units. The engine control unit 31 functions as a driver that controls or drives devices such as the print engine 26 and the scanner device 22. The input and output control unit 32 inputs, to the main control unit 30, signals and commands input to the controller 20 via the network I/F 28. The main control unit 30 further controls the input and output control unit 32 to access another apparatus via the network I/F 28.

Under the control of the main control unit 30, the image processing unit 33 generates rendering information based on print information included in an input print job. The rendering information is information for rendering an image to be formed in an image forming operation by the print engine 26, which functions as an image forming device. Further, the print information included in the print job is image information converted into a format compatible with the MFP 100 by a printer driver installed in an information processing apparatus such as the client PC 300. The operation and display control unit 34 displays information on the display panel 24, and transmits to the main control unit 30 information input via the display panel 24.

When the MFP 100 operates as a printer, the input and output control unit 32 first receives the print job via the network I/F 28. The input and output control unit 32 then transmits the received print job to the main control unit 30. The main control unit 30 receives the print job, and controls the image processing unit 33 to generate the rendering information based on the print information included in the print job.

After the image processing unit 33 generates the rendering information, the engine control unit 31 controls the print engine 26 based on the generated rendering information to form an image on the recording medium transported from the sheet feeding table 25. That is, the print engine 26 functions as the image forming device. The recording medium with the image formed thereon by the print engine 26 is ejected onto the sheet ejection tray 27.

The rendering information generated by the image processing unit 33 is directly stored in a storage device such as the HDD 14 in accordance with an instruction from the user, or is transmitted to an external apparatus via the input and output control unit 32 and the network I/F 28. The ADF 21 and the engine control unit 31 function as an image input unit.

When the MFP 100 operates as a copier, the image processing unit 33 generates the rendering information based on captured image information received from the scanner device 22 by the engine control unit 31 or image information generated by the image processing unit 33. Then, based on the rendering information, the engine control unit 31 drives the print engine 26 similarly as in the operation of the MFP 100 as the printer.

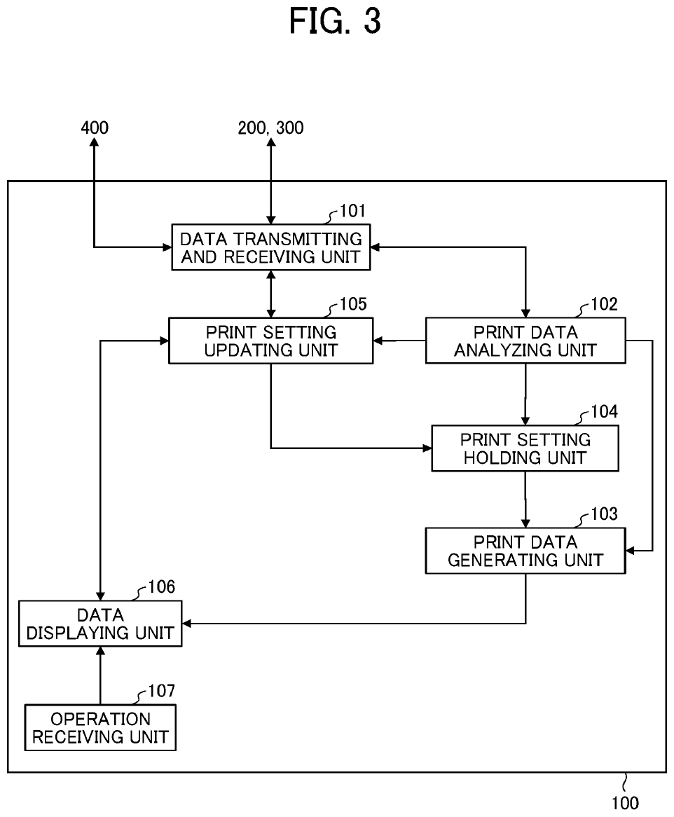

Functional blocks of the MFP 100 will be described with FIG. 3.

The MFP 100 includes a data transmitting and receiving unit 101, a print data analyzing unit 102, a print data generating unit 103, a print setting holding unit 104, a print setting updating unit 105, a data displaying unit 106, and an operation receiving unit 107. These functional blocks of the MFP 100 are implemented by a control program that cooperates with hardware resources of the main control unit 30 such as a processor (an example of a second processor).

The data transmitting and receiving unit 101 receives job data. The job data corresponds to the processing target information included in the print job transmitted from the client PC 300 or the printer server 200. The print job also includes job information related to print settings. The job information related to the print settings is an example of the processing condition information for the processing target information. The data transmitting and receiving unit 101 further transmits authentication information to the authentication server 400, and receives authentication result information from the authentication server 400. The authentication information will be described in detail later.

The print data analyzing unit 102 analyzes the contents of the job data received by the data transmitting and receiving unit 101, and transmits the analyzed contents of the job data to the print data generating unit 103 and the print setting updating unit 105.

Based on the job data analyzed by the print data analyzing unit 102 and the print settings held in the print setting holding unit 104, the print data generating unit 103 generates the image to be printed on the recording medium. Further, when the print setting updating unit 105 notifies the print data generating unit 103 of processing restriction information (i.e., an applied rule) for the image generated based on the information acquired from the print setting holding unit 104, the print data generating unit 103 generates the image by updating image generating conditions with the applied rule.

The print setting holding unit 104 holds information specifying the print settings (e.g., color or monochrome output, the number of print copies, and print imposition) analyzed by the print data analyzing unit 102.

Based on the information transmitted from the print data analyzing unit 102, the print setting updating unit 105 transmits a request for the processing restriction information (i.e., the applied rule) of the print data to the printer sever 200 via the data transmitting and receiving unit 101. The print setting updating unit 105 then receives the applied rule from the printer sever 200, and notifies the print data generating unit 103 of the received applied rule. The print setting updating unit 105 also notifies the data displaying unit 106 of the applied rule. If the job information related to the print settings (i.e., the processing condition information) held in the data displaying unit 106 is changed based on a notice from the operation receiving unit 107, the print setting updating unit 105 updates the applied rule to generate the image. The notice from the operation receiving unit 107 will be described later.

The data displaying unit 106 provides the user with interfaces (i.e., user interfaces) such as an interface for the user to input the authentication information to use the MFP 100 and an interface for displaying a list of print jobs executable with the authorization of the user. The data displaying unit 106 further provides the user with an interface for changing the print settings (i.e., applied conditions) of a specific print job selected from the list of print jobs.

The operation receiving unit 107 receives a user operation via a user interface provided by the data displaying unit 106. For example, the operation receiving unit 107 receives information of a change in the print settings (e.g., a change in the number of copies or the print side) of the specific print job selected from the list of print jobs, and notifies the print setting updating unit 105 of the change.

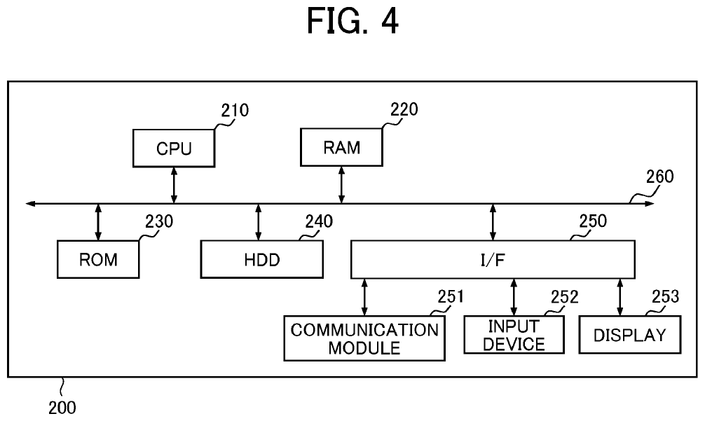

A hardware configuration of the printer server 200 of the embodiment will be described with FIG. 4.

As illustrated in FIG. 4, the printer server 200 of the embodiment is an information processing apparatus with functions equivalent to those of a commonly-used computer. The printer server 200 includes a CPU 210, a RAM 220, a ROM 230, an HDD 240, and an I/F 250, which are connected to each other via a common bus 260. The I/F 250 is connected to a communication module 251, an input device 252, and a display 253, for example. The communication module 251 is connected to the communication network 500 to perform data communication with the MFP 100 or the client PC 300. The input device 252 includes devices such as a keyboard and a mouse. The display 253 displays a user interface.

The CPU 210 is an arithmetic device that controls an overall operation of the printer server 200. The RAM 220 is a volatile storage medium capable of high-speed reading and writing of information, and is used as a work area when the CPU 210 processes the image information. The ROM 230 is a read-only nonvolatile storage medium that stores programs such as firmware programs. The HDD 240 is a nonvolatile storage medium with a high storage capacity capable of reading and writing information. The HDD 240 stores an operating system (OS) and various control programs and application programs, for example.

The I/F 250 connects the common bus 260 to various hardware components and networks, for example, and controls the connection. The communication module 251 is a communication interface for connecting the printer server 200 to the communication network 500 to communicate information between the printer server 200 and another apparatus via the communication network 500.

The printer server 200 with the above-described hardware configuration is an information processing apparatus that implements various processing functions with the arithmetic function of the CPU 210 from programs such as control programs stored in the ROM 230 and information processing programs (i.e., application programs) loaded on the RAM 220 from a storage medium such as the HDD 240. These processing functions form a software control unit including various functional modules of the printer server 200. A combination of the thus-configured software control unit and hardware resources including the above-described hardware configuration provides functional blocks that implement functions of the printer server 200 of the embodiment. The hardware resources include a processor (an example of a first processor).

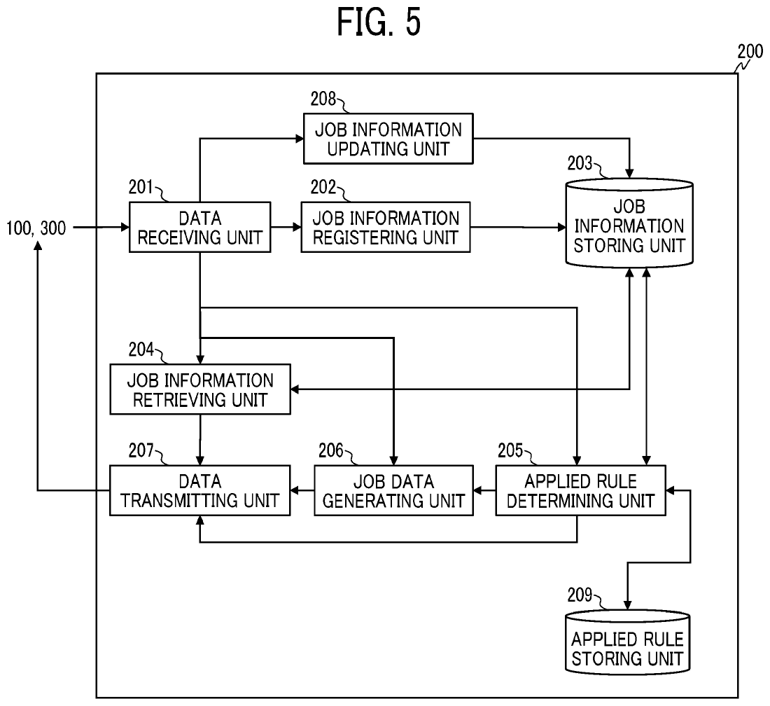

A functional configuration of the printer server 200 will be described with FIG. 5.

The printer server 200 includes a data receiving unit 201, a job information registering unit 202, a job information storing unit 203, a job information retrieving unit 204, an applied rule determining unit 205, a job data generating unit 206, a data transmitting unit 207, a job information updating unit 208, and an applied rule storing unit 209.

The data receiving unit 201 receives a print job from the MFP 100 or the client PC 300, and transmits job information included in the received print job to the job information registering unit 202. The data receiving unit 201 further receives a job information acquisition request from the MFP 100, and transmits the received job information acquisition request to the job information retrieving unit 204. The data receiving unit 201 further receives an applied rule acquisition request from the MFP 100, and transmits the received applied rule acquisition request to the applied rule determining unit 205. The data receiving unit 201 further receives a job information request from the MFP 100, and transmits the received job information request to the job data generating unit 206. The data receiving unit 201 further receives a printing result notice from the MFP 100 or the client PC 300, and transmits the received printing result notice to the job information updating unit 208.

The job information registering unit 202 stores in the job information storing unit 203 the job information included in the print job received from the data receiving unit 201.

The job information storing unit 203 stores the job information. The job information includes process settings (i.e., user-set processing conditions) used in the execution of a process related to the print job, and functions as an index of the print job.

Based on the job information acquisition request received from the data receiving unit 201, the job information retrieving unit 204 searches through the job information storing unit 203 for the job information, and transmits a search result to the data transmitting unit 207.

Based on the applied rule acquisition request received from the data receiving unit 201, the applied rule determining unit 205 searches through the applied rule storing unit 209 for the applied rule that applies to the print job based on the job information included in the applied rule acquisition request. If the applied rule storing unit 209 stores the applied rule, the applied rule determining unit 205 transmits the applied rule to the job data generating unit 206 and the data transmitting unit 207.

A functional block corresponding to the applied rule determining unit 205 may be removed from the printer server 200 and included in the MFP 100. In this case, the data receiving unit 201, which receives the applied rule acquisition request from the MFP 100, may search through the applied rule storing unit 209 for the applied rule, and the data transmitting unit 207 may transmit the retrieved applied rule to the MFP 100.

Based on the job information request received from the data receiving unit 201, the job data generating unit 206 generates job data based on the job information. If there is an applied rule that applies to the job information, the job data generating unit 206 generates the job data based on the applied rule. The job data generating unit 206 transmits the generated job data to the data transmitting unit 207.

In response to a request for data from a request source apparatus (i.e., the MFP 100 or the client PC 300), the data transmitting unit 207 transmits to the request source apparatus the requested data received from the corresponding one of the above-described functional blocks. Based on a request from the MFP 100, the data transmitting unit 207 transmits to the MFP 100 the job information and the job data of the print job to be subjected to the printing process in the MFP 100. The data transmitting unit 207 further transmits to the MFP 100 the applied rule (i.e., the processing restriction information) associated with the job information.

With the printing result notice received from the data receiving unit 201, the job information updating unit 208 updates the status of the job information stored in the job information storing unit 203 to “print completed.” With the status of the job information thus updated, the job information extracted in the retrieval process of the job information retrieving unit 204 is limited to that of a print job yet to be processed (i.e., printed).

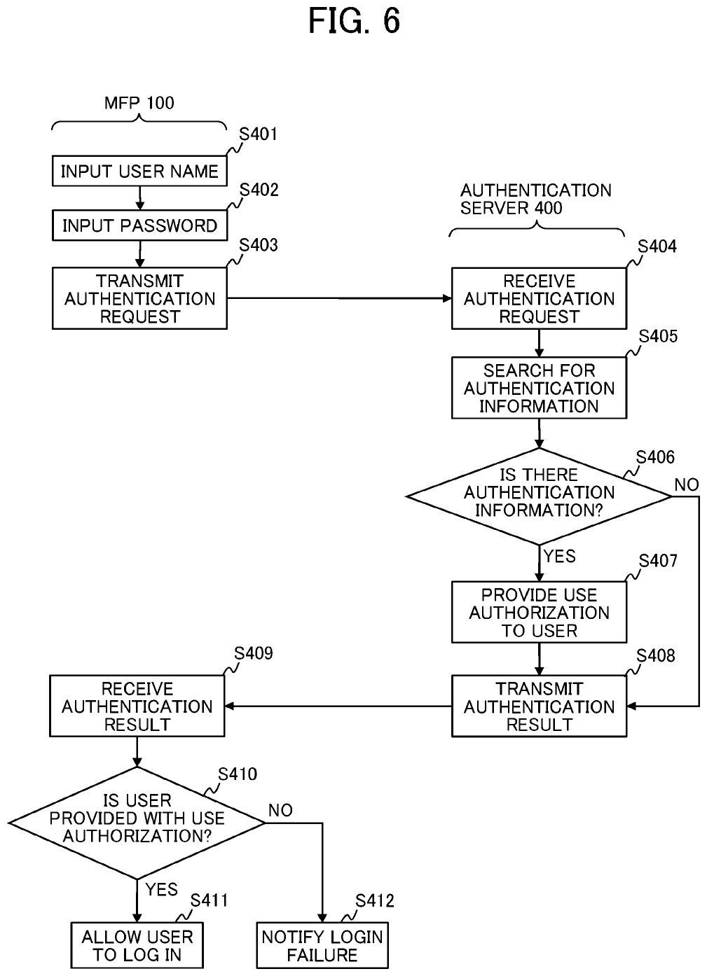

A procedure of a user authentication process performed in the print management system 1 of the embodiment will be described with FIG. 6.

The user inputs a user name (step S401) and then inputs a password (step S402) to the MFP 100 with the operation receiving unit 107 via a user interface provided by the data displaying unit 106 to log in to the MFP 100. The user interface provided here is an authentication screen. The user name is used to uniquely identify the user. The password is used to confirm the validity of the user. A combination of the user name and the password form authentication information of the user. The MFP 100 transmits an authentication request to the authentication server 400 via the data transmitting and receiving unit 101 (step S403). The authentication request includes the authentication information.

The authentication server 400 receives the authentication request (step S404), and searches through an authentication database for the same authentication information as the authentication information included in the authentication request (step S405). The authentication server 400 executes a process of determining whether the authentication information is stored in the authentication database (step S406). If the authentication information is stored in the authentication database (YES at step S406), the authentication server 400 provides the user having requested the authentication process with use authorization to use the functions of the MFP 100 (step S407). If the authentication information is not stored in the authentication database (NO at step S406), the authentication server 400 proceeds to step S408 without providing the user with the use authorization to use the functions of the MFP 100.

The authentication server 400 transmits an authentication result to the MFP 100 (step S408), and the MFP 100 receives the authentication result (step S409). If the user is provided with the use authorization (YES at step S410), the login process is normally completed. Thereby, the user is allowed to use applications and functions of the MFP 100 set by the use authorization (step S411). If the authentication information of the user is not stored in the authentication database and thus the use authorization is not provided to the user (NO at step S410), the login process fails. Therefore, the data displaying unit 106 displays a message notifying the failure of the login process (step S412).

In the authentication process executed by the MFP 100 and the authentication server 400, the user may input the authentication information with a previously registered IC card instead of inputting information such as the user name via the operation receiving unit 107. Further, the user may execute a registration process on the MFP 100 with an unregistered IC card.

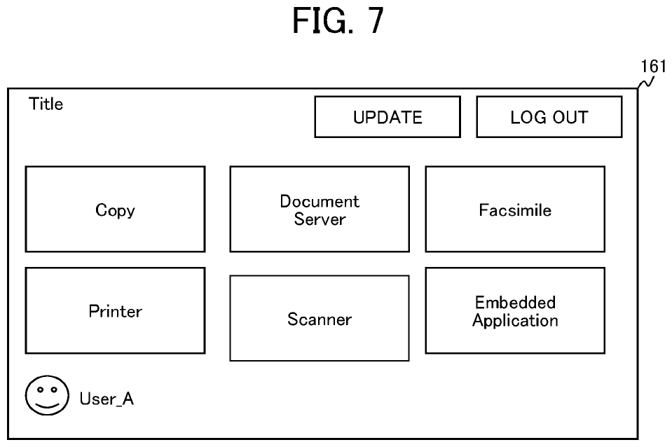

FIG. 7 illustrates an example of a launcher screen 161 displayed on the display panel 24 by the data displaying unit 106 of the MFP 100 at step S411. As illustrated in FIG. 7, the data displaying unit 106 of the MFP 100 displays on the display panel 24 link buttons linked to applications, such as a copy button, a printer button, and a scanner button. The user performs a selection operation on the displayed launcher screen 161 to select an application, and an instruction to start the operation of the selected application is received via the operation receiving unit 107. The launcher screen 161 thus facilitates the transition to the application desired to be used by the user.

The launcher screen 161 also includes other buttons such as a logout button and an update button to facilitate the user to execute a logout process after the use of the MFP 100 and a screen updating process. The layout of buttons in the launcher screen 161 may be freely changed to display the functions of the MFP 100 to the user in an appropriate fashion. Further, a link to an application that operates outside the MFP 100 (i.e., an embedded application) may be set in the launcher screen 161.

A description will be given of an exemplary data structure of a job information table stored in the printer server 200 of the embodiment.

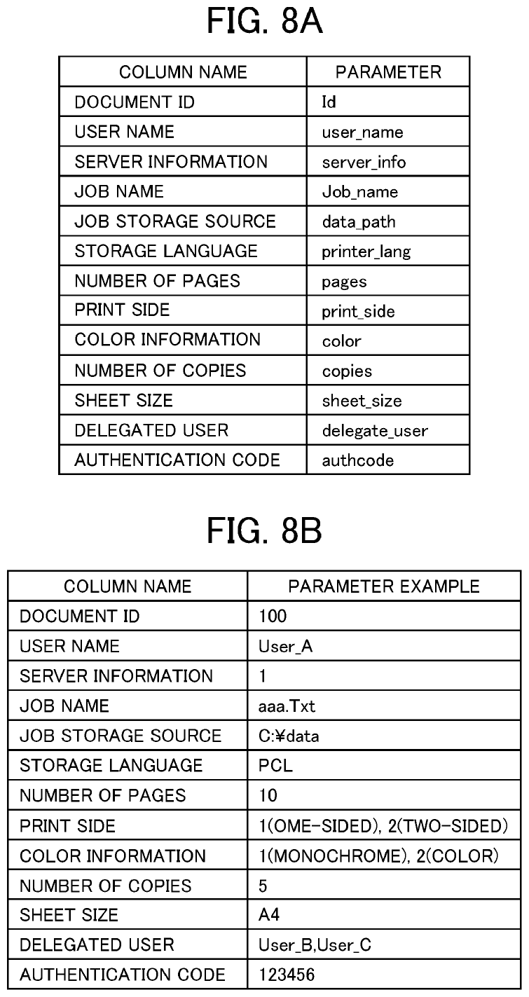

As illustrated in FIG. 8A, the job information includes items such as document identification (ID), user name, server information, job name, job storage source, storage language, number of pages, print side, color information, number of copies, sheet size, delegated user, and authentication code.

The document ID is used to uniquely identify document information to be printed. The user name represents the name of the user having executed a document storage process of storing a document in the printer server 200. The server information represents the printer server 200 on which the document storage process is executed. The job name represents the document name of the stored job data. The job storage source represents the location at which the job data is stored (i.e., present). The storage language represents a printer job language (PJL) used in the storage process by the user. The number of pages represents the number of pages of the job data. The print side represents the number of print sides of the job data. The color information represents the color information of the job data. The number of copies represents the number of prints to be made in the printing process of the job data. The sheet size represents sheet size information of the job data. The delegated user represents the name of the user authorized to print the document by proxy. The authentication code is used to apply simple security to the print document.

When the user executes the document storage process on the printer server 200, the printer server 200 reads the PJL of the job data, and stores the above-described information items in the job information table representing the information of the job data. FIG. 8B illustrates an example of parameters included in the job information corresponding to the job data. When a document is input to the printer server 200 from the print management system 1 of the embodiment, a user name “system” is registered for the document and used in the printing process by a guest user together with the authentication code.

A description will be given of an exemplary data structure of a server information table that stores server information including management information of the printer server 200 of the embodiment.

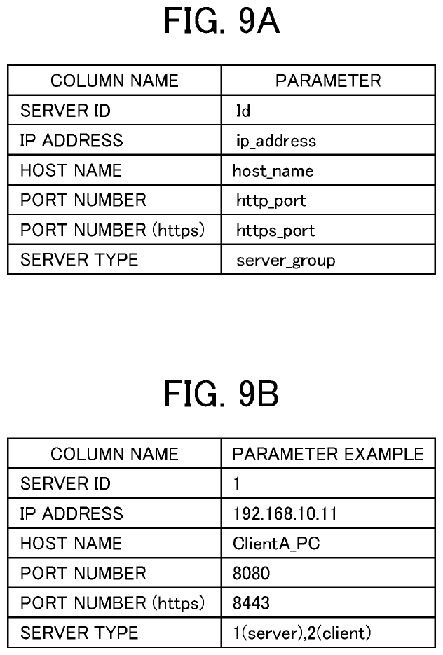

As illustrated in FIG. 9A, the server information includes items such as server ID, internet protocol (IP) address, host name, port number, port number (https), and server type.

The server ID is used to uniquely identify the printer server 200. The IP address represents the IP address of the printer server 200. The host name represents the host name of the printer server 200. The port number represents the port used in data communication with a client application executed on the MFP 100 or the client PC 300. The port number (https) represents the port used in encrypted communication with the MFP 100 or the client PC 300, for example. The server type indicates whether registered information is from the printer server 200 or a client tool of the client PC 300. The client tool will be described later.

FIG. 9B illustrates an example of parameters actually set in the server information table. In the printing process of the job data, a search process is executed with the foregoing job information table based on the server ID included in the server information table. The intended print job is acquired from the printer server 200 or the client PC 300 retrieved by the search process, and the printing process of the print job is executed by the MFP 100.

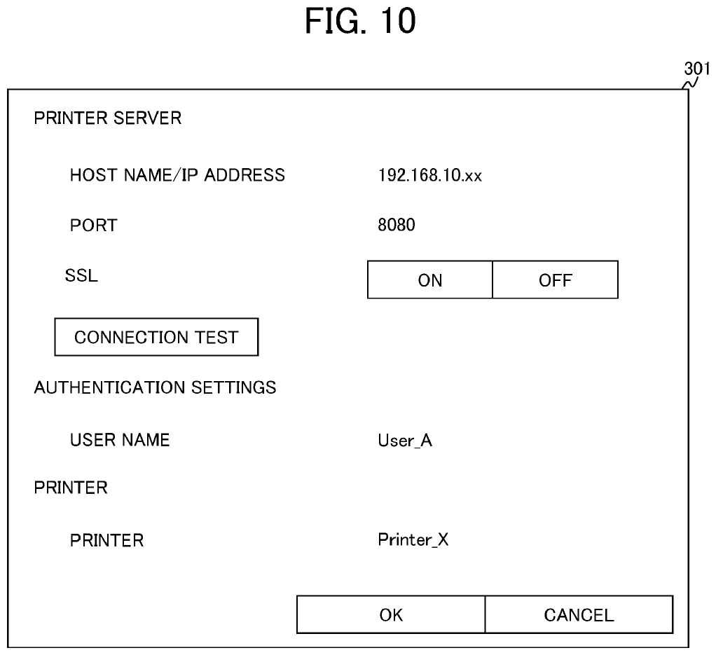

FIG. 10 illustrates an example of a setting screen 301 displayed by the client tool executed on the client PC 300. The client tool (also referred to as client tool program) is a software program installed and executed on the client PC 300 to enable communication between the client PC 300 and the printer server 200. On the setting screen 301 displayed by the client tool, the user is able to set items such as the host name, the IP address, the port number, and enabling or disabling of security setting (e.g., secure sockets layer: SSL) of the printer server 200, as illustrated in FIG. 10. Further, by operating a “connection test” button included in the setting screen 301, the user is able to check if the communication with the printer server 200 is normally performed. The setting screen 301 further enables the user to specify the user name of the user in the job data storage process and a driver that generates the job data in response to a print request from the MFP 100.

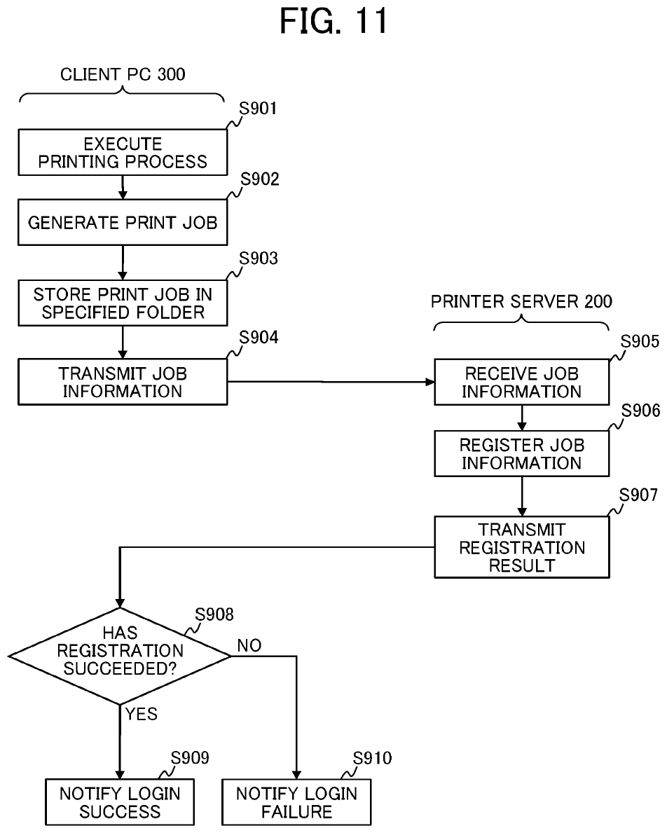

A procedure of a process of registering (i.e., storing), in the printer server 200 of the embodiment, the print job generated in the client PC 300 will be described with FIG. 11.

The client PC 300 first executes the printing process (step S901). Thereby, the data to be printed is transmitted to a driver program (i.e., a print driver) included in the client tool program executed on the client PC 300. Then, the print job is generated (step S902), and the job information (i.e., the processing condition information) for the job data (i.e., the processing target information) included in the print job is extracted from the print job. The generated print job is stored in a specified folder in the client PC 300 (step S903), and the job information including information of the storage location of the print job is transmitted to the printer server 200 (step S904). The job information includes setting information of the job data (i.e., the data to be printed) included in the print job.

The printer server 200 receives the job information (step S905), registers the received job information in a predetermined storage area (step S906), and transmits a registration result to the client PC 300 (step S907).

The client PC 300 checks the registration result transmitted from the printer server 200 to determine whether the registration has succeeded or failed (step S908). If the registration result indicates that the job information has successfully been registered (YES at step S908), the client PC 300 displays a message notifying the success of the registration (step S909). If the registration result indicates that the registration has failed (NO at step S908), the client PC 300 displays a message notifying the failure of the registration (step S910).

In the display process of step S909 or S910, the message may be displayed in a pop-up screen by the client tool. This display process facilitates the notification to the user of the result of the registration process. Further, with the above-described registration process, the job information (i.e., index) of the print job is stored in the printer server 200, and the job data (i.e., image data) included in the print job is stored in the client PC 300, on which the print job registration process is executed by the user.

A procedure of the printing process performed with the MFP 100 of the embodiment will be described.

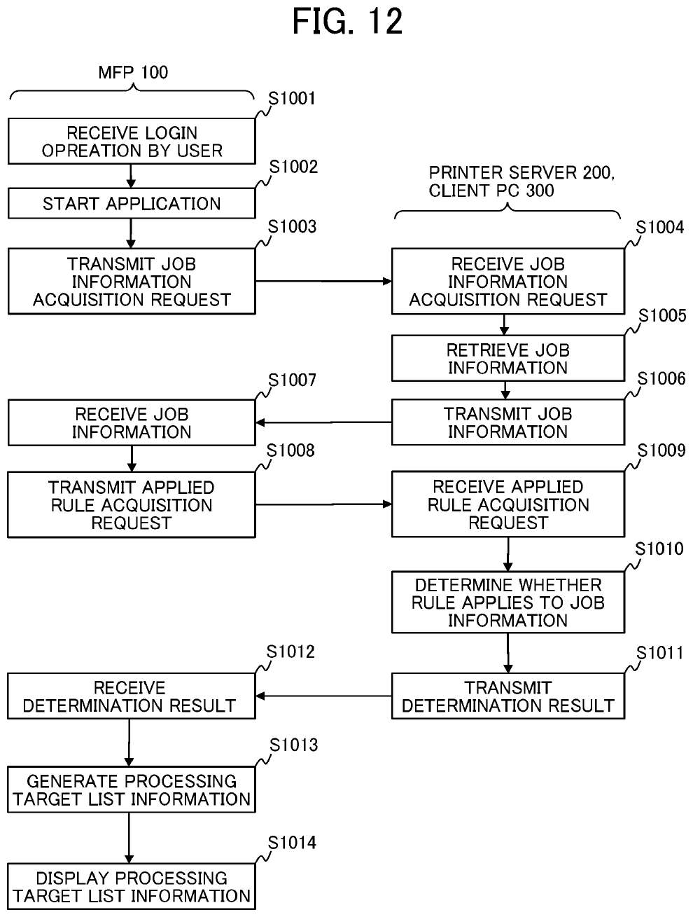

FIG. 12 is a sequence diagram illustrating a part of the procedure of the printing process executed in the print management system 1. The user first performs a login operation via the operation receiving unit 107 of the MFP 100 (step S1001). Specifically, the user inputs the user ID (i.e., individual identifying information) and the password (i.e., information for authentication) of the user. The input user ID and password are transmitted to the authentication server 400, and the authentication server 400 executes a process of checking if the same combination of user ID and password as that of the input user ID and password is registered in the authentication server 400. If the user is authenticated as a registered valid as a result of the checking process, the MFP 100 receives from the authentication server 400 information indicating that the user is authenticated, and starts an application executable in the MFP 100 (step S1002).

Then, based on the user ID of the authenticated user, the MFP 100 transmits the job information acquisition request to the printer server 200 or the client PC 300 (step S1003). The condition for transmitting the job information acquisition request to the client PC 300 may be limited to, for example, when the response from the printer server 200 to the job information acquisition request times out.

The printer server 200 or the client tool of the client PC 300 receives the job information acquisition request (step S1004), and executes a retrieval process based on user information transmitted from the MFP 100 to determine the presence or absence of the print job registered by the user (step S1005). If there is a job record (i.e., index) of the print job stored by the user, the printer server 200 or the client PC 300 transmits the job record to the MFP 100 as the job information (step S1006). If there are a plurality of job records of print jobs stored by the user, the printer server 200 or the client PC 300 transmits the job records in a batch to the MFP 100.

Then, the MFP 100 receives the job information (step S1007), and transmits the applied rule acquisition request to the printer server 200 or the client tool of the client PC 300 to check the processing restriction information (i.e., the applied rule) applied to the job information (step S1008).

The printer server 200 or the client tool of the client PC 300 receives the applied rule acquisition request (step S1009), and executes a determination process of determining whether the applied rule applies to the job information included in the applied rule acquisition request by referring to the information of the set rule (step S1010). Thereafter, the printer server 200 or the client tool of the client PC 300 transmits a determination result to the MFP 100 (step S1011).

Then, the MFP 100 receives the determination result (step S1012), and generates processing target list information in the print setting updating unit 105 based on the job information received at step S107 and the determination result received at step S1012 (step S1013). Then, with the data displaying unit 106, the MFP 100 displays the processing target list information on the display panel 24 (step S1014).

If the MFP 100 includes a storage device corresponding to the applied rule storing unit 209 of the printer server 200, and if the storage device stories the processing restriction information (i.e., the applied rule) used in the print management system 1, the MFP 100 may execute a process corresponding to that of step S1010 after the process of step S1007, and then may proceed to the process of step S1013. In other words, the applied rule determination process of step S1010 is not necessarily executed in the printer server 200 or the client PC 300.

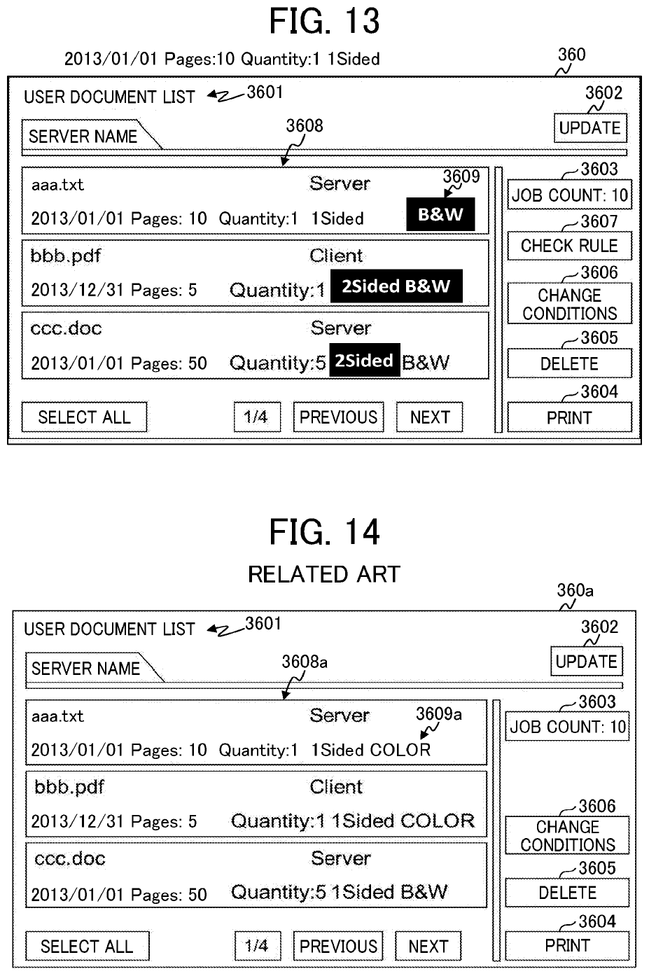

An example of a list display screen 360 displayed at step S1014 will be described with FIG. 13.

As illustrated in FIG. 13, the list display screen 360 displayed on the MFP 100 includes a label 3601, an update button 3602, a print job count field 3603, a print button 3604, a delete button 3605, a change conditions button 3606, a check rule button 3607, and job buttons 3608. The label 3601 displays a title and a server name. The update button 3602 is used to update the screen. The print job count field 3603 displays the number of print jobs stored by the user. The print button 3604 is used to issue an instruction to execute the printing process. The delete button 3605 is used to execute a process of deleting a print job. The change conditions button 3606 is used to change printing conditions at the time of storing a print job. The check rule button 3607 is used to display a screen for checking the applied rule that applies to the printing conditions. The job buttons 3608 display information of selectable print jobs. As well as the above-described buttons and items, the list display screen 360 further includes a button for selecting all selectable items and page switch buttons for switching the page to be displayed when it is difficult to display all print jobs in one screen.

The job buttons 3608 are generated based on the job information. Therefore, when the user selects from the job buttons 3608 the job information corresponding to the job data desired to be printed or deleted by operating the corresponding job button 3608, the job data corresponding to the selected job information is acquired from the printer server 200 or the client PC 300. The job buttons 3608 display the job information of the print jobs stored by the authenticated user, and thus the confidentiality of the print jobs is maintained.

Based on the job information of the print jobs, the job buttons 3608 display a plurality of information items. For example, the job buttons 3608 display information items such as the document name assigned to the job data, the date and time of storage of the job data, and output condition information 3609 including the number of pages, the number of copies (i.e., quantity), the number of print sides, and color or monochrome output. The job buttons 3608 further display the storage location at which the job data corresponding to the job information is stored. The storage location is displayed as text such as “Server” or “Client” in the example of FIG. 13, but may be displayed not as text but as an icon, for example.

FIG. 14 illustrates, as a comparative example, a list display screen 360a according to related art. As compared with the list display screen 360, the list display screen 360a does not include the check rule button 3607. Further, the list display screen 360a includes job buttons 3608a including output condition information 3609a. As compared with the output condition information 3609a in the job buttons 3608a, the output condition information 3609 in the job buttons 3608 is highlight-displayed for user visibility. Such highlight-display is not found in the job buttons 3608a.

In the list display screen 360, the output condition information 3609 displayed with an effect such as a highlight effect indicates that the processing restriction information (i.e., the applied rule) specified in the printer server 200, for example, as a preset value is applied to the output conditions set by the user when registering the print job. For example, in the list display screen 360 in FIG. 13 as compared with the list display screen 360a in FIG. 14, “B&W” (i.e., black and white print) is highlighted in the print job displayed in the uppermost job button 3608 as compared with unhighlighted “COLOR” (i.e., color print) in the print job displayed in the uppermost job button 3608a. This highlighting of “B&W” indicates that, although the output conditions set by the user include “COLOR,” “COLOR” is forcibly changed to “B&W” since “B&W” is the applied rule specified in the print management system 1 as the preset value to be uniformly applied to all print jobs.

The display of the job information in the job buttons 3608 indicating that the output conditions (i.e., processing conditions) of the print job specified by the user have been changed by the applied rule is not limited to the highlight display illustrated in FIG. 13. For example, a changed part of the output conditions may be displayed in a different color from that of the rest part of the output conditions. Further, the changed part of the output conditions may be displayed in a different text font or size (e.g., increased size) from that of the rest part of the output conditions, or may be flash-displayed, for example. Any other displaying method facilitating the user to recognize the change in the output conditions may be employed.

The MFP 100 of the embodiment thus generates for display the processing target list information (i.e., a list of job data items) as the job buttons 3608 illustrated in FIG. 13. If the processing conditions (i.e., output conditions) specified by the user to be applied to the print job have forcibly been changed by the applied rule in the job buttons 3608, therefore, the user is able to recognize the change in the processing conditions without checking the contents of the job data. Consequently, the user is able to easily know the change in the processing conditions before executing a process on a target print job.

A display example of a screen for checking the applied rule will be described.

In the MFP 100 of the embodiment, in response to user operation of the check rule button 3607 included in the list display screen 360, a rule display screen 361 illustrated in FIG. is displayed on the display panel 24. The rule display screen 361 may be displayed when the user touches the output condition information 3609 in the list display screen 360.

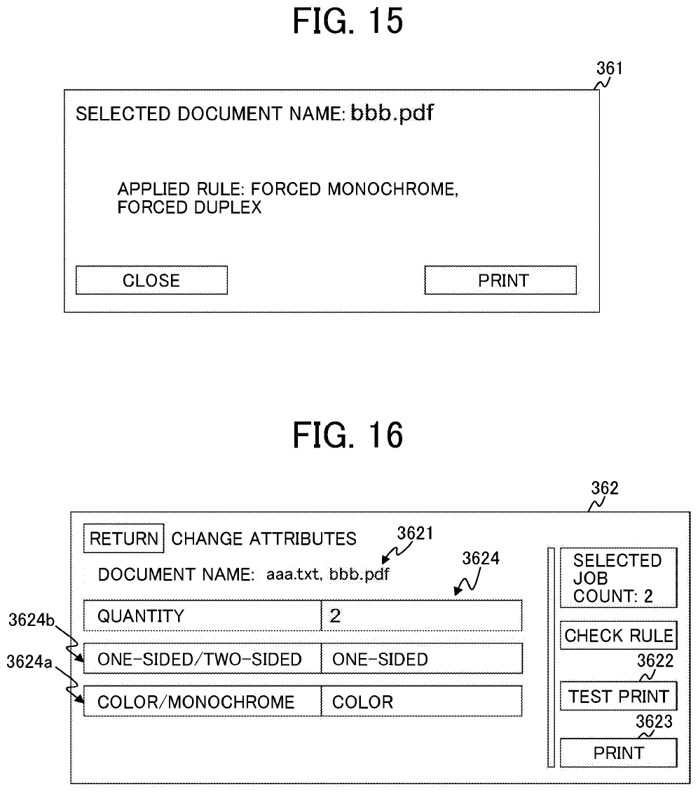

As illustrated in FIG. 15, the rule display screen 361 includes items such as the document name assigned to the selected job data and the applied rule applied as the output conditions of the job data. If the user operates a “CLOSE” button included in the rule display screen 361, the rule display screen 361 is closed to return to the list display screen 360. If the user operates a “PRINT” button included in the rule display screen 361, the output process is executed to output the job data corresponding to the displayed job information. The rule display screen 361 may be displayed as a dialogue screen or a pop-up screen, for example, and the method of displaying the rule display screen 361 is not limited to a particular method.

A display example of a screen for changing the output conditions will be described.

The MFP 100 of the embodiment updates the output conditions (i.e., processing conditions) in response to user operation input via the operation receiving unit 107 on the list display screen 360 displayed on the display panel 24 via the data displaying unit 106. The user operates, via the operation receiving unit 107, the change conditions button 3606 included in the list display screen 360 displayed on the display panel 24. If the display panel 24 is a touch panel, the user performs this operation by pressing the change conditions button 3606 displayed on the touch panel. With this operation, an attribute change screen 362 illustrated in FIG. 16 is displayed on the display panel 24.

The attribute change screen 362, which displays the output conditions set for the print job, provides an interface that, in response to the above-described operation performed on the item forcibly changed by the applied rule, enables the user to temporarily change (i.e., update) the output conditions as desired. In the present example, settings “QUANTITY,” “ONE-SIDED/TWO-SIDED,” and “COLOR/MONOCHROME” are illustrated as changeable attributes.

The attribute change screen 362 includes a document name field 3621 displaying the document name assigned to the selected job data, a test print button 3622, a print button 3623, and an output condition field 3624 displaying the output conditions set (or changed) for the job data.

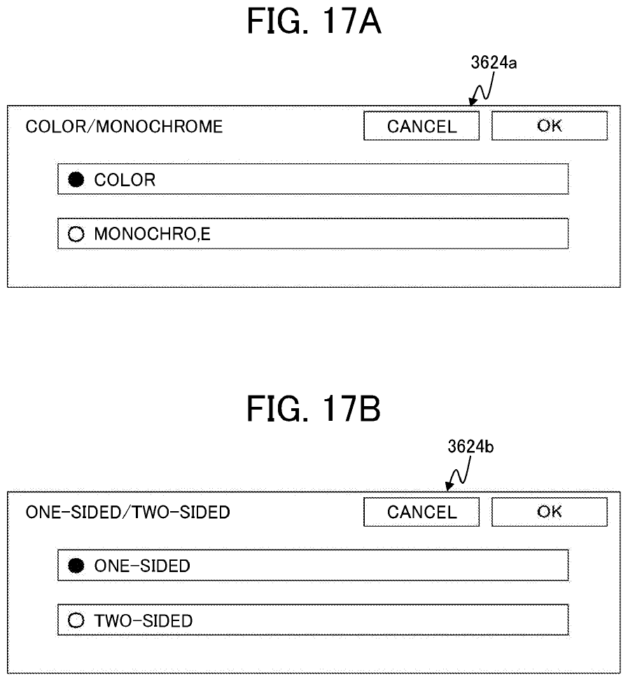

For example, if the user operates a color attribute condition field 3624a of the output condition field 3624 related to a setting “COLOR/MONOCHROME,” the screen illustrated in FIG. 17A is displayed. If the user changes the color attribute condition from “COLOR” to “MONOCHROME” and presses an “OK” button in the thus-displayed screen, “COLOR” is changed to “MONOCHROME” in the color attribute condition field 3624a of the attribute change screen 362 illustrated in FIG. 16. If the user then operates the print button 3623, the printing process is executed with the changed attribute.

Further, if the user operates an editing condition field 3624b of the output condition field 3624 related to a setting “ONE-SIDED/TWO-SIDED,” the screen illustrated in FIG. 17B is displayed. If the user changes the editing condition from “ONE-SIDED” to “TWO-SIDED” and presses an “OK” button on the thus-displayed screen, “ONE-SIDED” is changed to “TWO-SIDED” in the editing condition field 3624b of the attribute change screen 362 illustrated in FIG. 16. If the user then operates the print button 3623, the printing process is executed with the changed attribute.

If the user operates the test print button 3622 after changing the attribute, the printing process is executed to print out one copy even if the quantity is set to two or more.

As described above, according to the embodiment, through the operation of the change conditions button 3606 included in the list display screen 360, the user is able to change as desired the output conditions of the print job restricted by the applied rule and thereby easily execute a desired printing process.

For example, if there are a plurality of print jobs stored by the user, as in the list display screen 360 illustrated in FIG. 13, and if the user wants to execute the print job corresponding to a document name “bbb.pdf” with a color print setting specified by the user at the time of storing the print job, the user operates the corresponding output condition information 3609 (i.e., 2Sided B&W) to transition to the attribute change screen 362 illustrated in FIG. 16. Then, the user selects “COLOR” and operates the “OK” button in the screen illustrated in FIG. 17A, and operates the print button 3623 in the attribute change screen 362. If the output conditions set by the user at the time of storing the print job have forcibly been changed by the applied rule, therefore, the user is able to easily recognize the change in the output conditions. Further, if the user desires to update the changed output conditions, the user is able to easily change the output conditions by performing the above-described operation.

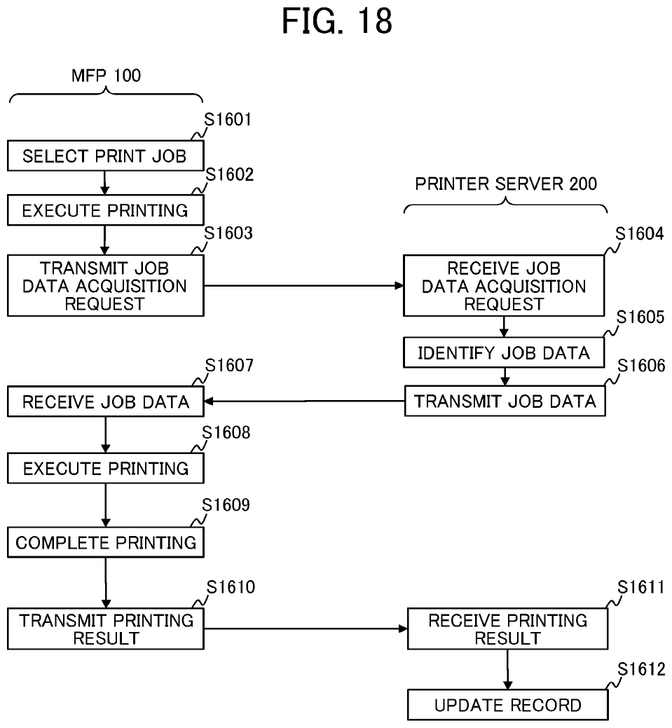

A procedure of a first example of the printing process by the MFP 100 of the embodiment will be described with a sequence diagram of FIG. 18.

As described above with FIG. 11, when the user performs the login operation on the MFP 100 and is authenticated as a valid user, the display panel 24 of the MFP 100 displays the list display screen 360, which facilitates the user to recognize the job information stored by the user and whether the rule is applied to the output conditions set by the user for the job data corresponding to the job information.

The user selects a specific print job from print jobs corresponding to the plurality of job buttons 3608 (i.e. a job list) in the displayed list display screen 360 (step S1601), and operates the print button 3604. Thereby, the MFP 100 starts the printing process (step S1602). After the start of the printing process, the MFP 100 determines whether the job data of the print job is stored in the printer server 200 or the client PC 300. The following description will be given on the assumption that the job data of the print job is stored in the printer server 200.

The MFP 100 transmits a job data acquisition request to the printer server 200 (step S1603). The job data acquisition request includes the job information of the selected print job. The printer server 200 receives the job data acquisition request (step S1604), and identifies the job data based on the job information included in the received job data acquisition request (step S1605). Then, if the job information includes information related to the applied rule, the printer server 200 converts the identified job data into job data reflecting the applied rule.

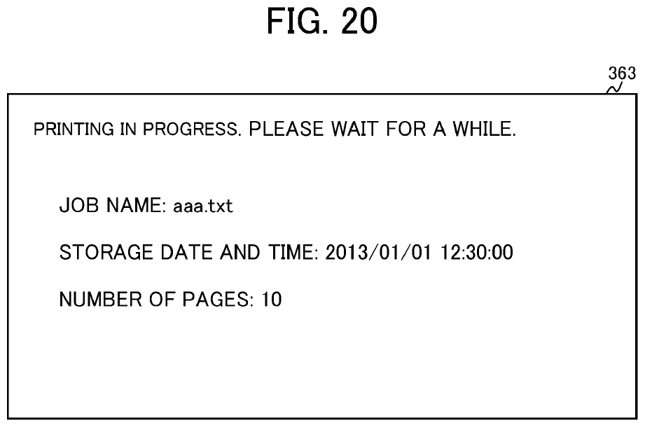

The printer server 200 transmits the job data to the MFP 100 (step S1606). The MFP 100 receives the job data (step S1607), and executes the printing process with the job data (steps S1608 and S1609). In this process, the display panel 24 of the MFP 100 displays a process display screen 363 illustrated in FIG. 20. Then, an output result based on the print job is obtained.

After the printing process is completed, the MFP 100 transmits a printing result to the printer server 200 (step S1610). The printer server 200 receives the printing result (step S1611), and executes a process of updating the record of the corresponding job data with the received printing result (step S1612). The print management system 1 of the embodiment thus appropriately executes the printing process and the printing result updating process.

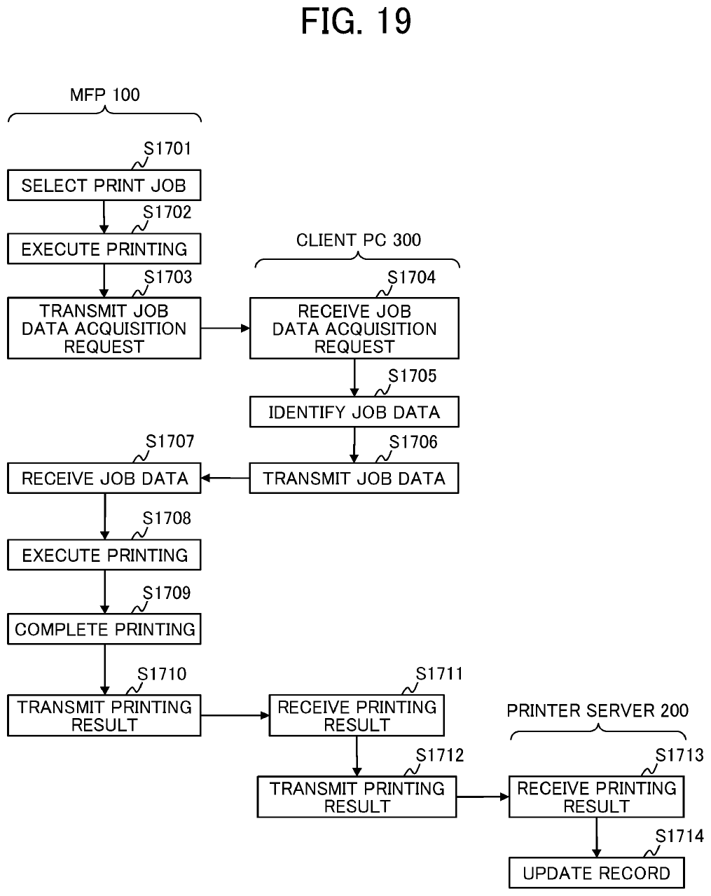

A procedure of a second example of the printing process by the MFP 100 of the embodiment will be described with a sequence diagram of FIG. 19.

The procedure of the second example of the printing process illustrated in FIG. 19 is different from that of the first example of the printing process illustrated in FIG. 18 in that the job data is stored in the client PC 300.

The user first selects a specific print job from the print jobs corresponding to the plurality of job buttons 3608 (i.e. a job list) in the displayed list display screen 360 (step S1701), and operates the print button 3604. Thereby, the MFP 100 starts the printing process (step S1702). After the start of the printing process, the MFP 100 determines whether the job data of the print job is stored in the printer server 200 or the client PC 300. As described above, it is assumed here that the job data of the print job is stored in the client PC 300.

The MFP 100 transmits a job data acquisition request to the client PC 300 (step S1703). The job data acquisition request includes the job information of the selected print job. The client PC 300 receives the job data acquisition request (step S1704), and identifies the job data based on the job information included in the received job data acquisition request (step S1705). Then, if the job information includes information related to the applied rule, the client PC 300 converts the identified job data into job data reflecting the applied rule.

The client PC 300 transmits the job data to the MFP 100 (step S1706). The MFP 100 receives the job data (step S1707), and executes the printing process with the job data (steps S1708 and S1709). In this process, the display panel 24 of the MFP 100 displays the process display screen 363 illustrated in FIG. 20. Then, an output result based on the print job is obtained.

After the printing process is completed, the MFP 100 transmits a printing result to the client PC 300 (step S1710). The client PC 300 receives the printing result (step S1711), and transmits the received printing result to the printer server 200 (step S1712). The printer server 200 receives the printing result (step S1713), and executes a process of updating the record of the corresponding job data with the received printing result (step S1714).

When the job data is stored in the client PC 300, the MFP 100 searches for the host apparatus storing the job data by referring to the host name or the IP address included in the job information, and transmits the job data acquisition request to the host apparatus.

The print management system 1 of the embodiment thus appropriately executes the printing process and the printing result updating process. Accordingly, the user is able to appropriately execute the print job without being consciously aware of which of the printer server 200 and the client PC 300 is being used.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An information processing system including an information processing apparatus and a server apparatus connected to each other via a communication network,
the server apparatus including a first processor configured to
transmit processing target information and processing restriction information to the information processing apparatus in response to a request from the image processing apparatus, the processing target information being to be processed by the information processing apparatus, and the processing restriction information being associated with the processing target information, and
the information processing apparatus including a second processor configured to
transmit the request for the processing target information and the processing restriction information to the server apparatus, and
apply the processing restriction information to information for displaying a list of items of the processing target information to generate processing target list information for display.

2. The information processing system of claim 1, wherein the processing target list information includes information indicating a change in processing condition information for the processing target information, the change being caused by the processing restriction information.

3. The information processing system of claim 2, wherein the second processor of the information processing apparatus generates the processing target list information to display a changed part of the processing target list information differently from a part of the processing target list information other than the changed part, the changed part of the processing target list information corresponding to the change in the processing condition information.

4. The information processing system of claim 2, wherein the second processor of the information processing apparatus
receives an input from a user to update the processing condition information for the processing target information, and
allows the user to change the processing condition information for the processing target information included in the processing target list information with the change in the processing condition information.

5. The information processing system of claim 1, wherein the request for the processing target information and the processing restriction information is input to the information processing apparatus by a user, and
wherein based on a result of authentication of the user, the second processor of the information processing apparatus transmits the request to the server apparatus, the server apparatus storing the processing target information corresponding to the request.

6. An information processing apparatus connected to a server apparatus via a communication network, the information processing apparatus comprising a processor configured to
transmit a request for processing target information and processing restriction information to the server apparatus, the processing restriction information being associated with the processing target information, and
apply the processing restriction information to information for displaying a list of items of the processing target information to generate processing target list information for display.

7. The information processing apparatus of claim 6, wherein the processing target list information includes information indicating a change in processing condition information for the processing target information, the change being caused by the processing restriction information.

8. The information processing apparatus of claim 7, wherein the processor generates the processing target list information to display a changed part of the processing target list information differently from a part of the processing target list information other than the changed part, the changed part of the processing target list information corresponding to the change in the processing condition information.

9. The information processing apparatus of claim 7, wherein the processor
receives an input from a user to update the processing condition information for the processing target information, and
allows the user to change the processing condition information for the processing target information included in the processing target list information with the change in the processing condition information.

10. The information processing apparatus of claim 6, wherein the request for the processing target information and the processing restriction information is input to the information processing apparatus by a user, and
wherein based on an authentication result of the user, the processor transmits the request to the server apparatus, the server apparatus storing the processing target information corresponding to the request.

11. An information processing method executed by an information processing apparatus connected to a server apparatus via a communication network, the information processing method comprising:
transmitting a request for processing target information and processing restriction information to the server apparatus, the processing restriction information being associated with the processing target information, and
applying the processing restriction information to information for displaying a list of items of the processing target information to generate processing target list information for display.
